(19) United States
(12) Patent Application Publication
(10) Pub. No.: US 2015/0134240 A1
(43) Pub. Date: May 14, 2015

(54) IMITATION SOUND GENERATION SYSTEM AND MAP DATABASE

(71) Applicants: Shigeaki Yamada, Hyogo (JP); Mitsuo Shimotani, Tokyo (JP); Makoto Mikuriya, Tokyo (JP)

(72) Inventors: Shigeaki Yamada, Hyogo (JP); Mitsuo Shimotani, Tokyo (JP); Makoto Mikuriya, Tokyo (JP)

(73) Assignee: Mitsubishi Electric Corporation, Tokyo (JP)

(21) Appl. No.: 14/400,778

(22) PCT Filed: Jun. 19, 2012
(86) PCT No.: PCT/JP2012/065622

§ 371 Date: Nov. 12, 2014

(51) Int. Cl. G01C 21/34

(52) U.S. Cl. CPC G01C 21/34
USPC 701/461; 701/522; 701/532

(57) ABSTRACT

An imitation sound generation system is provided that accurately informs a user of a road environment corresponding to a current location, by an imitation sound. A navigation apparatus, which serves as an imitation sound generation system, includes a map data storage apparatus that stores road network data including data regarding links each representing each road in a road network, a vehicle information acquiring unit that acquires a current location, and a travelling road determining unit that specifies a link to which the current location belongs. The map data storage apparatus stores a plurality of pieces of imitation sound data each being associated with each link. A controller determines a piece of imitation sound data that is associated with the link to which the current location belongs, on the basis of the plurality of pieces of imitation sound data.

### TECHNICAL FIELD

The present invention relates to an imitation sound generation system for generating imitation sounds according to the circumstances, and particularly relates to a system such as a navigation apparatus that provides information regarding the current location.

### BACKGROUND ART

As for imitation sound generation systems for use in vehicle navigation apparatuses (car navigation apparatuses), for example, Patent Document 1 below proposes a technique for, when the location of a vehicle comes close to a predetermined place on a map, reproducing an imitation sound (environmental sound) corresponding to that place. Moreover, for example, Patent Document 2 below proposes a technique for registering sound data in association with each position on a map and indicating by a specific sound that the location of a vehicle is getting close to a registered position.

### PRIOR ART DOCUMENT

### Patent Document

[Patent Document 1] Japanese Patent Application Laid-open No. 2006-266902

[Patent Document 2] Japanese Patent Application Laid-open No. 6-207832

### SUMMARY OF INVENTION

### Problems to be Solved by the Invention

It is helpful and effective for drivers who are driving their vehicles to accurately perceive driving environments (e.g., road conditions, traffic situation, or weather). Perceiving driving environments is, however, difficult because, for example, drivers when driving at night are not able to perceive road conditions and the weather in the sky through their eyes. It is also difficult to determine road conditions from the sound of a travelling vehicle (travelling sound) or perceive the intensity of wind when the windows of the vehicle are closed, such as during use of the air conditioner.

With the techniques disclosed in Patent Documents 1 and 2, sound data is associated with a predetermined “location,” and the user (driver) is informed of the fact that the vehicle is getting close to that location, by a sound. These techniques are not the one for informing the user of driving environments around the vehicle.

The present invention has been achieved in order to solve such problems, and it is an object of the present invention to provide an imitation sound generation system that uses an imitation sound to accurately inform a user of road environments corresponding to the current location.

### Means for Solving Problems

The imitation sound generation system according to the present invention includes a storage that stores road network data that includes data regarding links, each representing each road in a road network, a current location acquiring unit that acquires a current location, a road determining unit that specifies a link to which the current location belongs, an imitation sound determining unit that determines a piece of imitation sound data associated with a link to which the current location belongs, from among a plurality of pieces of imitation sound data, and an imitation sound generator that outputs an imitation sound that corresponds to a piece of imitation sound data determined by the imitation sound determining unit.

### Advantageous Effects of the Invention

The imitation sound generation system of the present invention that generates an imitation sound corresponding to a road (link) at the current location enables a user to perceive information corresponding to the state of play on the road (e.g., road conditions, a traffic situation, and weather conditions) by an imitation sound.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 illustrates a configuration of a car navigation apparatus to which an imitation sound generation system according to Embodiment 1 is applied.

FIG. 2 illustrates a data structure in a map database according to Embodiment 1.

FIG. 3 is a diagram for explaining a relationship in road data between links and nodes.

FIG. 4 illustrates a data structure of a link record stored in the map database according to Embodiment 1.

FIG. 5 shows examples of road-surfacing material codes.

FIG. 6 shows examples of road sign codes.

FIG. 7 shows an exemplary in-vehicle imitation sound data list (travelling sound).

FIG. 8 shows another exemplary in-vehicle imitation sound data list (environmental sounds).

FIG. 9 shows another exemplary in-vehicle imitation sound data list (natural sounds).

FIG. 10 shows an exemplary outside-vehicle imitation sound data list (alarm sounds).

FIG. 11 shows another exemplary in-vehicle imitation sound data list (alarm sounds).

FIG. 12 is a flowchart of operations performed by the navigation apparatus according to Embodiment 1 to generate an imitation sound.

### DESCRIPTION OF EMBODIMENTS

### Embodiment 1

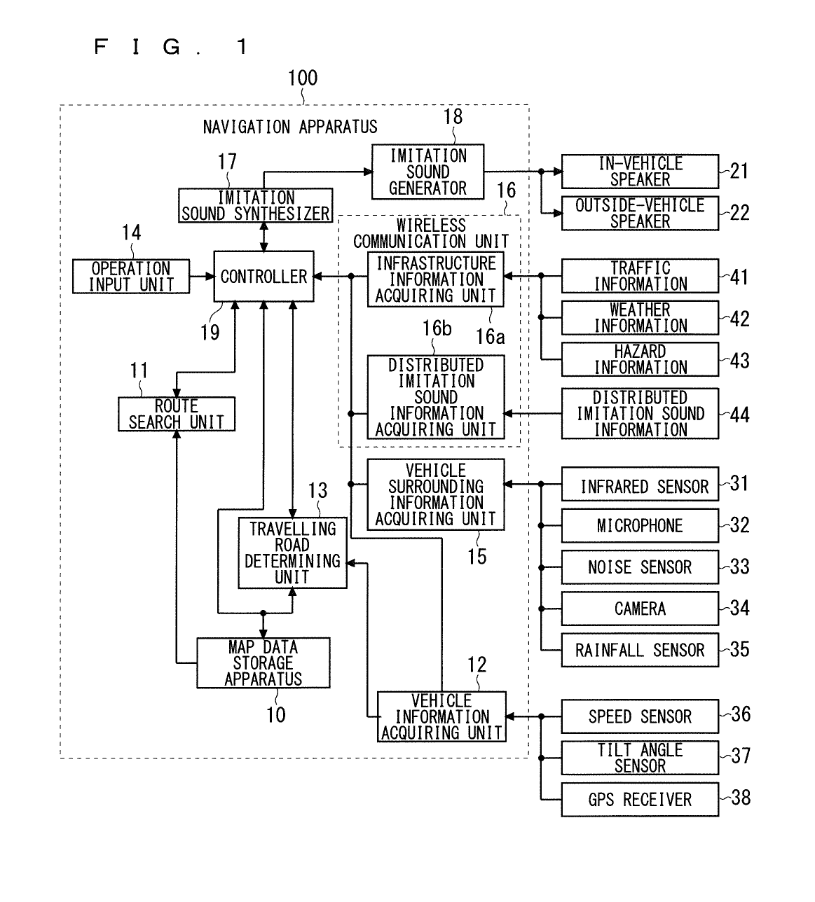

FIG. 1 illustrates a configuration of an imitation sound generation system according to Embodiment 1. Here, a car navigation apparatus that incorporates therein the imitation sound generation system according to the present invention will be described as a specific example of the configuration.

As illustrated in FIG. 1, a navigation apparatus 100 includes a map data storage apparatus 10, a route search unit 11, a vehicle information acquiring unit 12, a travelling road determining unit 13, an operation input unit 14, a vehicle surrounding information acquiring unit 15, a wireless communication unit 16, an imitation sound synthesizer 17, an imitation sound generator 18, and a controller 19, which will all be described later.

The map data storage apparatus 10 is a storage that stores a map database and various types of imitation sound data. The route search unit 11 is means for obtaining a route between two points on a map (e.g., an optimal route from the current location to the destination) on the basis of road network data in the map database. The navigation apparatus 100 guides a driver, using a display unit (not shown) or a sound output unit (in-vehicle speaker 21) so that the vehicle travels along the route obtained by the route search unit 11.

The vehicle information acquiring unit 12 is means for acquiring information (vehicle information) regarding the driving state of the vehicle. The vehicle information acquiring unit 12 acquires the speed of the vehicle, the tilt angle of the road surface, and the current location of the vehicle, respectively, from a speed sensor 36, a tilt angle sensor 37, and a GPS receiver 38 that are mounted on the vehicle. In other words, the vehicle information acquiring unit 12 functions as a current location acquiring unit that acquires the current location on the basis of information received by the GPS receiver 38.

The travelling road determining unit 13 is means for specifying the current location on a map, i.e., a road on which the vehicle is travelling, through a map matching technique using the current location acquired by the vehicle information acquiring unit 12, the vehicle information acquired by the vehicle information acquiring unit 12, and the road network data in the map database. The operation input unit 14 is a user interface through which a user operates the navigation apparatus 100, so the user is able to set the destination through the operation input unit 14.

The vehicle surrounding information acquiring unit 15 is means for acquiring information (external environmental information) regarding external environments, using sensors of the vehicle. The vehicle surrounding information acquiring unit 15 acquires information such as an obstacle around the vehicle, the presence of a human being, sounds outside the vehicle, and rainfall conditions from an infrared sensor 31, a microphone 32, a noise sensor 33 (sound sensor), a camera 34 (image sensor), and a rainfall sensor 35 (rain sensor) that are mounted on the vehicle.

The wireless communication unit 16 may, for example, be a vehicle information and communication system (VICS: registered trademark) receiver, a dedicated short range communication (DSRC) system, a wireless local area network (LAN) terminal, or a mobile phone. The wireless communication unit 16 includes an infrastructure information acquiring unit 16a that receives external environmental information distributed from various types of infrastructures (called simply “infrastructures”), and a distributed imitation sound information acquiring unit 16b that receives distributed imitation sound information 44 distributed from an imitation sound distribution service.

The infrastructure information acquiring unit 16a acquires information such as traffic information 41, weather information 42, and hazard information 43 from information distribution services provided by various types of infrastructures. The external environmental information acquired by the above-described vehicle surrounding information acquiring unit 15 is information that is unique to each vehicle (vehicle surrounding information), but the external environmental information received by the infrastructure information acquiring unit 16a is information (infrastructure distribution information) that is distributed in common to vehicles that are located within a certain area.

The distributed imitation sound information 44 received by the distributed imitation sound information acquiring unit 16b includes new imitation sound data associated with specific roads and may be used to update the imitation sound data stored in the map data storage apparatus 10, for example. In other words, the distributed imitation sound information acquiring unit 16b functions as an imitation sound data acquiring unit that acquires new imitation sound data through communication.

The controller 19 controls operations of the constituent elements of the navigation apparatus 100 and also functions as an imitation sound determining unit that selects an imitation sound that is to be output from the in-vehicle speaker 21 and an outside-vehicle speaker 22 of the vehicle. Specifically, the controller 19 performs processing for determining which imitation sound is to be output from the in-vehicle speaker 21 and the outside-vehicle speaker 22, on the basis of the current location (travelling road) determined by the travelling road determining unit 13 and various types of information acquired by the vehicle information acquiring unit 12, the vehicle surrounding information acquiring unit 15, and the wireless communication unit 16.

The imitation sound synthesizer 17 combines one or more pieces of imitation sound data selected by the controller 19 and inputs an audio signal that corresponds to the combined imitation sound data to the imitation sound generator 18. The imitation sound generator 18 that includes an amplifier drives the in-vehicle speaker 21 and the outside-vehicle speaker 22 and generates an imitation sound in accordance with the audio signal received from the imitation sound synthesizer 17.

Now, the map database and the imitation sound data that are stored in the map data storage apparatus 10 will be described.

FIG. 2 illustrates a data structure in a map database 200 stored in the map data storage apparatus 10. As illustrated in FIG. 2, the map database 200 includes road network data 210 indicating a road network, and an in-vehicle imitation sound data list 221 and an outside-vehicle imitation sound data list 222 that are information indicating a plurality of pieces of imitation sound data, each being associated with each road.

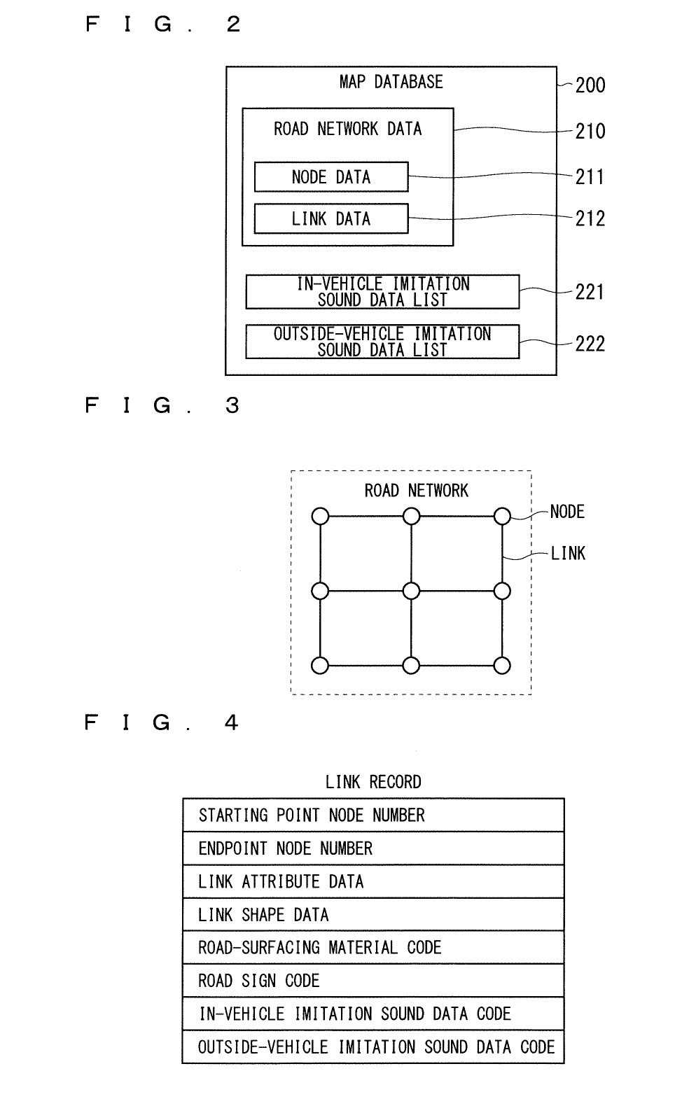

In the road network data 210, information regarding the road network is represented by “nodes” and “links” as illustrated in FIG. 3, the nodes corresponding to specific positions (e.g., intersections) on roads, and the links corresponding to roads between nodes. The nodes and the links are each given a unique number.

The road network data 210 includes node data 211 that indicates links connected to each node, and link data 212 that indicates nodes connected to each link. In general, the node data 211 includes a plurality of “node records” in which numbers of links (link numbers) connected to each node are described, whereas the link data 212 includes a plurality of “link records” in which numbers of nodes (node numbers) connected to each link are described.

FIG. 4 illustrates a data structure of a link record included in the link data 212. As illustrated in FIG. 4, the link record according to Embodiment 1 includes a starting point node number, an endpoint node number, link attribute data, link shape data, a road-surfacing material code, a road sign code, an in-vehicle imitation sound data code, and an outside-vehicle imitation sound data code.

The starting point node number and the endpoint node number are numbers of nodes connected to both ends of the link (the direction of the link (starting point and endpoint) is determined at the time of creating the road network data). The link attribute data is data representing the attribute of a road corresponding to the link and includes, for example, information such as the width of the road, the number of traffic lanes, and the type of the road, i.e., whether the road is a highway, a toll road, or an open road. The link shape data includes information indicating the shape of the center line of the road corresponding to the link. These pieces of information are information that is also included in each link record stored in the navigation apparatus generally used at the present time.

In the present embodiment, the link record includes, in addition to the above pieces of information, a road-surfacing material code that is an identifier indicating the material of the surface of the road corresponding to the link, a road sign code that is an identifier indicating a road sign on the road, an in-vehicle imitation sound data code that is an identifier indicating in-vehicle imitation sound data associated with the link, and an outside-vehicle imitation sound data code that is an identifier indicating outside-vehicle imitation sound data associated with the link.

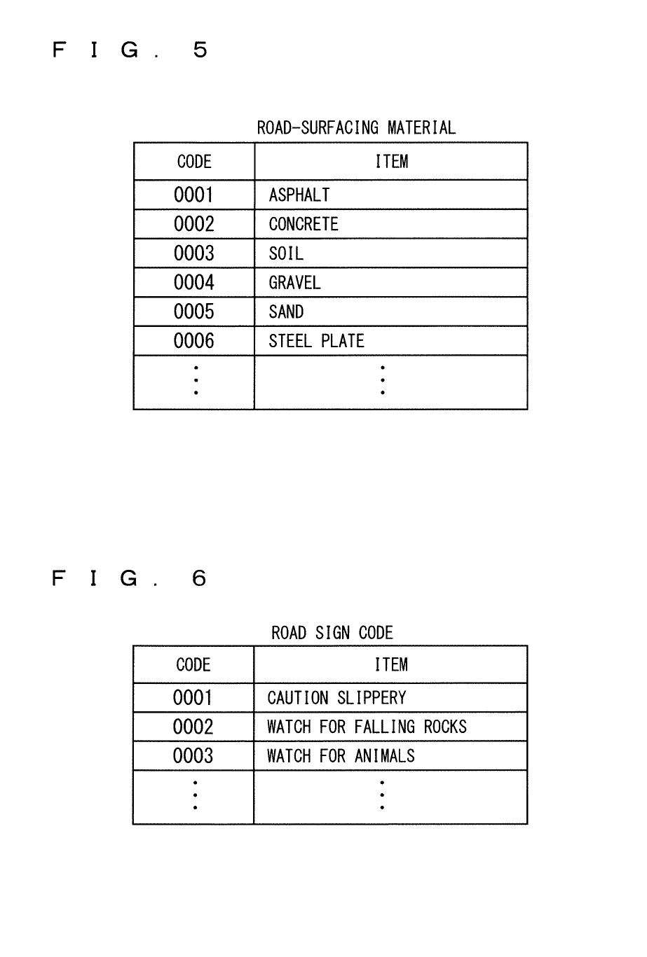

FIG. 5 shows examples of the road-surfacing material code. For example, if the link corresponds to an asphalt road, the link record for that link describes the road-surfacing material code as “0001.” FIG. 6 shows examples of the road sign code. For example, the link record for a link that corresponds to a road with a “CAUTION SLIPPERY” sign describes the road sign code as “0001.”

The road-surfacing material code and the road sign code may each have a plurality of values. For example, the link record for a link that corresponds to a road including both concrete and soil parts describe the road-surfacing material code as two values “0002” and “0003.” Similarly, the link record for a link that corresponds to a road with two road signs, “WATCH FOR FALLING ROCKS” and “WATCH FOR ANIMALS,” describes the road sign code as two values “0002” and “0003.”

Referring back to FIG. 2, the in-vehicle imitation sound data list 221 is a list that indicates a correspondence relationship between the imitation sound data and the in-vehicle imitation sound data code described in the link record. The outside-vehicle imitation sound data list 222 is a list that indicates a correspondence relationship between the imitation sound data and the outside-vehicle imitation sound data code described in the link record. The controller 19 serving as the imitation sound determining unit in FIG. 1 is capable of specifying imitation sound data associated with each link by referencing the in-vehicle imitation sound data code and the outside-vehicle imitation sound data code, which are described in the link record in the link data 212, the in-vehicle imitation sound data list 221, and the outside-vehicle imitation sound data list 222.

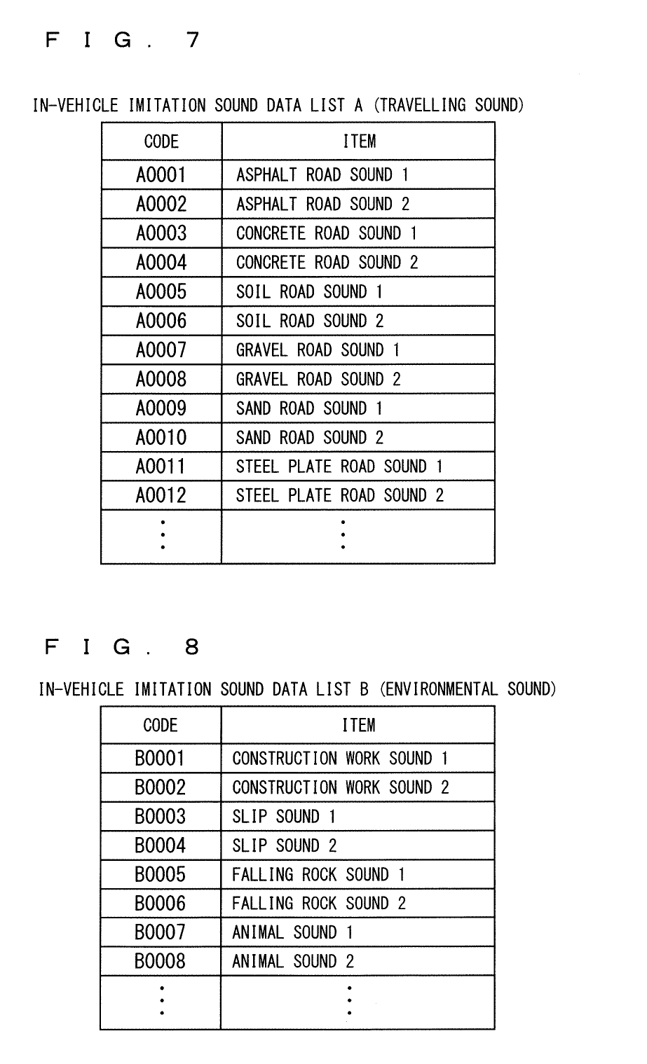

In the present embodiment, the in-vehicle imitation sound data list 221 contains a plurality of lists stored by category. FIGS. 7 to 9 show examples of such lists for different categories. The “item” field in these tables describes the name of the imitation sound for convenience of description, but in actuality, it describes information for reading out imitation sound data, such as the storage location of the imitation sound data (e.g., the address in the map data storage apparatus 10).

An in-vehicle imitation sound data list A illustrated in FIG. 7 shows correspondence between imitation sound data regarding the travelling sound and the in-vehicle imitation sound data code. Because the travelling sound varies depending on the road-surfacing material, imitation sound data is prepared for each type of road-surfacing materials. For example, the link record for a link that corresponds to an asphalt road (a link with a road-surfacing material code of 0001 in FIG. 5) describes the in-vehicle imitation sound data code as “A0001” or “A0002,” which indicate the sound of the vehicle travelling on an asphalt road. In this way, if there are a plurality of pieces of imitation sound data containing similar contents, which of the codes is to be described in the link record may be selected by user preference.

An in-vehicle imitation sound data list B illustrated in FIG. 8 shows correspondence between imitation sound data regarding the sound of a surrounding environment (environmental sound) and the in-vehicle imitation sound data code. For example, the link record for a link that corresponds to a road with a “CAUTION SLIPPERY” sign (i.e., the link with a road sign code of 0001 in FIG. 6) describes the in-vehicle imitation sound data code as “B0003” or “B0004,” which indicates the sound of the vehicle being slipped (slip sound).

The link record for a link that corresponds to a road within a construction site, which is indicated by the traffic information 41 acquired by the infrastructure information acquiring unit 16a, describes the in-vehicle imitation sound data code as “B0001” or “B0002,” which indicates the sound of construction work. In particular, when the vehicle includes a plurality of in-vehicle speakers 21 and is able to specify a site where construction work is being carried out (i.e., the direction from the vehicle), the sound of construction work may be generated from an in-vehicle speaker 21 located closer to the construction site in order to enable the user to perceive the construction site by the imitation sound.

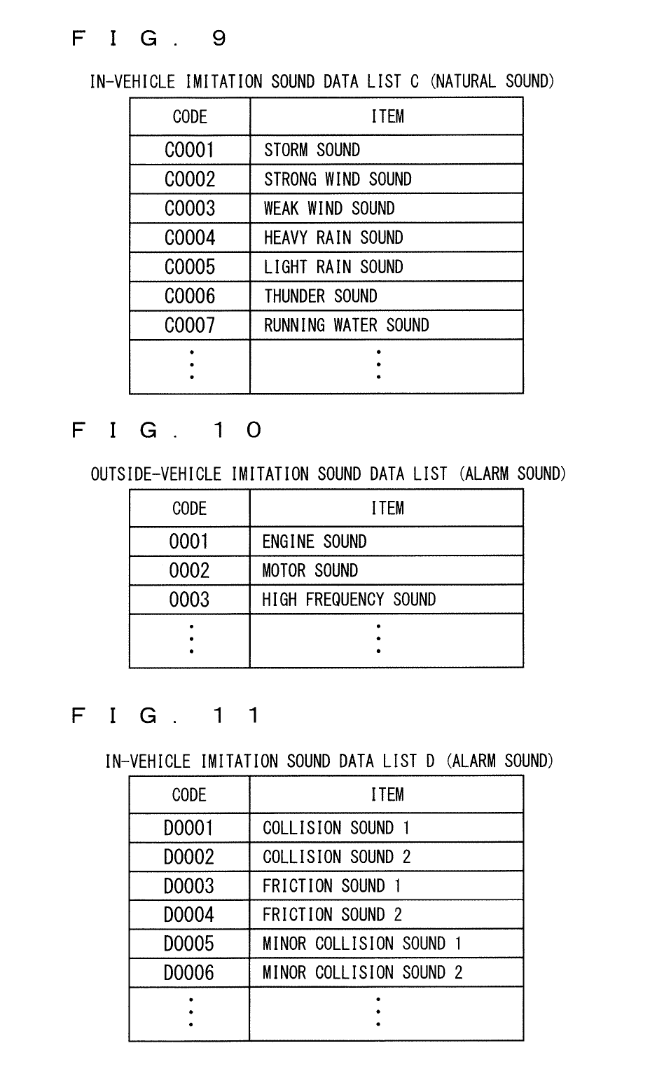

An in-vehicle imitation sound data list C illustrated in FIG. 9 shows correspondence between imitation sound data regarding the sound of a natural phenomenon such as a climate (natural sound) and the in-vehicle imitation sound data code. For example, the link record for a link that corresponds to a road within an area where a storm warning has been issued according to the weather information 42 describes the in-vehicle imitation sound data code as “C0001,” which indicates a storm sound, and the link record for a link that corresponds to a road within an area where strong-wind advisories have been issued describes the in-vehicle imitation sound data code as “C0002,” which indicates the sound of a strong wind.

The outside-vehicle imitation sound data list 222 (FIG. 2) stores a list of sounds (alarm sounds) that indicates the presence of the vehicle to people around the vehicle as a warning. FIG. 10 shows an example of the outside-vehicle imitation sound data list 222. Which of the alarm sounds is to be associated with each link may be defined according to the road-surfacing material or attribute of the road, or may be set by user preference. Note that the outside-vehicle imitation sound data list 222 may also include a plurality of lists stored by category as in the example of the in-vehicle imitation sound data list 221 described above.

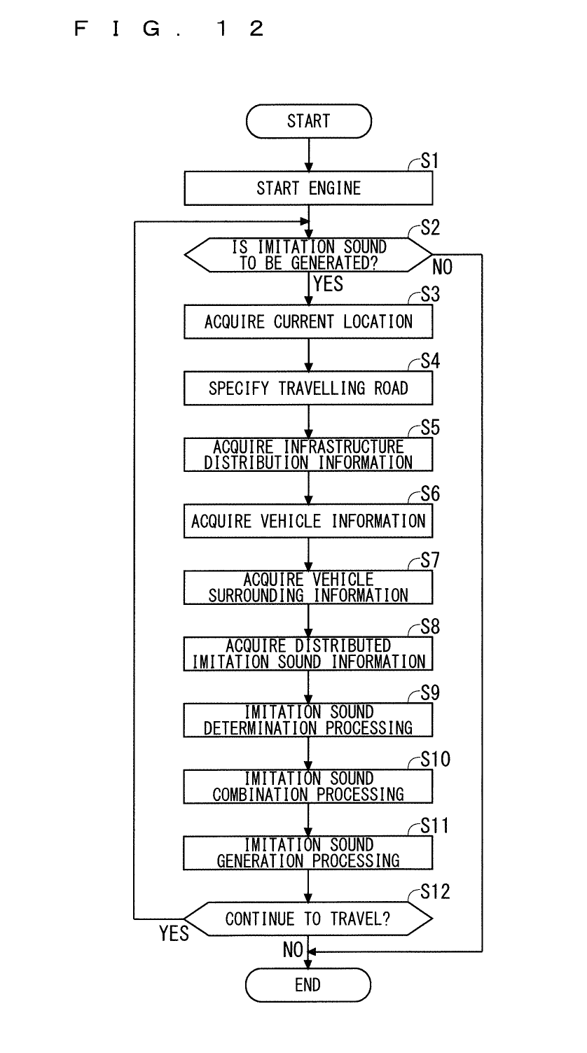

In the present embodiment, the map data storage apparatus 10 also stores imitation sound data that is unfamiliar to being recorded in link records. FIG. 11 shows an example of such data. An in-vehicle imitation sound data list D illustrated in FIG. 11 shows correspondence between imitation sound data regarding the sound (alarm sound) to warn the driver of attention and the in-vehicle imitation sound data code. The imitation sound data indicates an imitation sound that is produced at times when obstacles (including human beings), other vehicles, or the like have been detected around the vehicle (with the infrared sensor 31, the microphone 32, the noise sensor 33, or the camera 34, for example).

A conceivable use of the imitation sound data in the in-vehicle imitation sound data list D would be that when an obstacle has been detected in the travelling direction of the vehicle, the controller 19 specifies the in-vehicle imitation sound data code “D0001” or “D0002” so that a collision sound is output from the in-vehicle speaker 21 of the vehicle. Another conceivable use would be that when an obstacle has been detected beside or under the vehicle, the controller 19 specifies the in-vehicle imitation sound data code “D0003” or “D0004” so that a friction sound is output from the in-vehicle speaker 21. In this way, the alarm sounds are assumed to be produced at times when an event that requires the user to play attention has occurred. Thus, although unfamiliar to applications that require association with links, the alarm sounds may also be described in link records and associated with links by user preference.

Next is a description of operations performed by the navigation apparatus 100 (imitation sound generation system) according to Embodiment 1 to generate an imitation sound. FIG. 12 is a flowchart of the operations.

Upon starting of the engine of the vehicle (step S1), the navigation apparatus 100 causes the controller 19 to determine whether or not to generate an imitation sound during traveling (step S2). Whether or not to generate an imitation sound can be set arbitrarily by the user operating the operation input unit 14. If settings are such that imitation sounds are not to be generated (NO in step S2), the imitation sound generating operation ends.

If settings are such that imitation sounds are to be generated (YES in step S2), the controller 19 causes the vehicle information acquiring unit 12 to acquire the current location of the vehicle (step S3) and causes the travelling road determining unit 13 to specify a road (link) on which the vehicle is travelling (step S4).

Then, the controller 19 causes the infrastructure information acquiring unit 16a to acquire the external environmental information (infrastructure distribution information) such as the traffic information 41, the weather information 42, and the hazard information 43 that are distributed from infrastructures (step S5). The controller 19 further causes the vehicle information acquiring unit 12 to acquire the vehicle information such as the speed of the vehicle and the tilt angle of the road surface (step S6), then causes the vehicle surrounding information acquiring unit 15 to acquire the external environmental information (vehicle surrounding information) that is unique to the vehicle (step S7), and then causes the distributed imitation sound information acquiring unit 16b to acquire the distributed imitation sound information 44 (step S8).

On the basis of the information collected in the above steps, the controller 19 performs imitation sound determination processing for selecting one or more imitation sounds that are to be output from the in-vehicle speaker 21 or the outside-vehicle speaker 22 (step S9). Pieces of imitation sound data selected by the controller 19 are combined by the imitation sound synthesizer 17 (step S10), and the resultant data passes through the imitation sound generator 18 and is output from the in-vehicle speaker 21 or the outside-vehicle speaker 22 (step S11).

If the vehicle continues to travel (YES in step S12), the procedure returns to step S2, and steps S2 to S11 are repeatedly performed. If the vehicle has stopped travelling and the engine is stopped (NO in step S12), the imitation sound generating operation ends.

Now, the details of the above-described imitation sound determination processing (step S9) will be described, using a specific example. First, the controller 19 acquires the in-vehicle imitation sound data code and the outside-vehicle imitation sound data code that are described in the link record of the link corresponding to the travelling road and further references the in-vehicle imitation sound data list 221 and the outside-vehicle imitation sound data list 222 so as to select imitation sound data corresponding to the road.

For example, if the in-vehicle imitation sound data code is described as “A0001, B0003” (FIGS. 7 and 8), “Asphalt Road Sound 1” and “Slip Sound 1” are selected. The link record describes in advance the in-vehicle imitation sound data code that corresponds to the road-surfacing material of the corresponding link and road signs on that link. By listening to the imitation sounds of the asphalt road sound and the slip sound that are output from the in-vehicle speaker 21, the driver is able to perceive that the travelling road has an asphalt road surface and a “CAUTION SLIPPERY” sign is on the section of the road.

Similarly, an “animal sound” is output from the in-vehicle speaker 21 when travelling on a road with a “WATCH FOR ANIMALS” sign, and a “sound of falling rocks” is output when travelling on a road with a “WATCH FOR FALLING ROCKS” sign. The driver is thus able to accurately perceive the presence of such road signs.

If the in-vehicle imitation sound data code is described as “C0001” (FIG. 9) in the link record, for example, “Storm Sound” is selected. The link record describes in advance the in-vehicle imitation sound data code for a natural sound according to the weather information 42. The driver who listens to the storm sound output from the in-vehicle speaker 21 is thus able to perceive that a storm warning has been issued for the area where the vehicle is travelling.

An imitation sound may also be selected by combining a plurality of pieces of information. For example, in the case where a “CAUTION POSSIBLE FLOODING” sign is on the travelling road and heavy rain advisories (or warning) have been issued according to the weather information 42, a running water sound may be generated as a natural sound (FIG. 9). This is because, even with a “CAUTION POSSIBLE FLOODING” sign on the road, flooding will not occur if no rain falls.

The distributed imitation sound information 44 acquired by the wireless communication unit 16 includes new pieces of imitation sound data associated with roads (links). The distributed imitation sound information 44 is distributed when some changes are made to road-surfacing materials or the locations of road signs.

For example, if asphalt has been peeled off and soil is exposed on an asphalt road for temporal construction work, imitation sound data regarding a soil road sound associated with that road is distributed as the distributed imitation sound information 44. In such a case, two pieces of imitation sound data, i.e., the original imitation sound data (asphalt road sound) described in the link record and the new imitation sound data (soil road sound) included in the distributed imitation sound information 44, are associated with the same road, but in this case, the new imitation sound data is selected with priority. Such preferential selection of new imitation sound data enables the user to receive information near the current state of play on the road through the imitation sound.

Note that the distributed imitation sound information 44 may also be used to update the in-vehicle imitation sound data code in the link record. For example, when a soil road is paved with asphalt in the process of road improvement, the in-vehicle imitation sound data code in the link record for a link that corresponds to that road will be changed from the code representing the soil road sound to the code representing the asphalt road sound. This maintains the in-vehicle imitation sound data code in the link record up-to-date, thus enabling the user to receive information near the current state of play on the road through the imitation sound.

The controller 19 is also able to rewrite the in-vehicle imitation sound data code in the link record in accordance with the vehicle's unique external environmental information acquired by the vehicle surrounding information acquiring unit 15 and the vehicle information acquired by the vehicle information acquiring unit 12. For example, the in-vehicle imitation sound data code (natural sound) in the link record for a link that corresponds to the travelling road may be switched between a code representing a heavy rain sound and a code representing a light rain sound in accordance with the amount of rainfall detected by the rainfall sensor 35. The in-vehicle imitation sound data code (travelling sound) in the link record corresponding to the travelling road may also be switched in accordance with the speed of the vehicle detected by the speed sensor 36 or the angle of the road surface detected by the tilt angle sensor 37, for example. This enables the user to receive the vehicle information and the external environmental information in real time through the imitation sound.

As described above, the navigation apparatus 100 of the present embodiment that generates an imitation sound corresponding to the travelling road (link) enables the user (driver) to accurately perceive information regarding the travelling environment of the vehicle such as road surface conditions, traffic situations, and the weather. Since the imitation sound changes in accordance with the vehicle information and the external environmental information, the user is also able to understand such information through the imitation sound.

While the above description take the example of the case where the information acquired by the infrastructure information acquiring unit 16a, such as the traffic information 41, the weather information 42, or the hazard information 43, does not contain imitation sound data, it may contain imitation sound data corresponding to the content of the information. In other words, the infrastructure information acquiring unit 16a may also function as an imitation sound data acquiring unit that acquires new imitation sound data through communication.

For example, the weather information 42 regarding a rainfall probability may include imitation sound data representing the sound of rain in accordance with the rainfall probability, and the weather information 42 regarding wind velocity information may include imitation sound data representing the sound of a wind in accordance with the wind velocity. When imitation sound data is included in the weather information 42 regarding the rainfall probability, the link record corresponding to each road describes an imitation sound data code representing the sound of rain included in the weather information 42, in accordance with the rainfall probability for the corresponding area. This makes it possible to set a great number of types (e.g., 10 types in units of 10%) of imitation sound data in accordance with the numerical value of the rainfall probability even if the map data storage apparatus 10 stores only two types of rain sounds (heavy rain sound and light rain sound) as illustrated in FIG. 9, thus allowing the user to be provided with much detailed information.

### Embodiment 2

While Embodiment 1 takes the example of the case where an imitation sound such as the travelling sound is set for each link, Embodiment 2 describes an example in which, when the current location of the vehicle has moved from a highway (or a toll road) to an open road, a specific imitation sound (e.g., a brake sound) different from the sound specified by the link record for a link corresponding to that road (open road) is output for a certain period of time after the movement.

Immediately after having moved from a highway to an open road, the driver unconsciously tends to speed because his/her eyes are used to high-speed driving. This can be prevented by warning the user that the vehicle has moved to the open road, by an imitation sound different from the normal sound.

### Embodiment 3

While Embodiment 1 describes the configuration in which an imitation sound (alarm sound) is output from the in-vehicle speaker 21 and the outside-vehicle speaker 22 when the vehicle surrounding information acquiring unit 15 has detected an obstacle (including a human being) around the vehicle, this function is effective for use in parking areas rather than for use on travelling roads. This is because, in parking areas, many people who are going to get on and off their vehicles are walking around the vehicle.

In view of this, in Embodiment 3, the map data storage apparatus 10 also stores data regarding parking areas on a map and the controller 19 controls and causes the imitation sound synthesizer 17 and the imitation sound generator 18 to output a predetermined imitation sound from the in-vehicle speaker 21 and the outside-vehicle speaker 22 when any of the sensors of the vehicle (e.g., the infrared sensor 31, the microphone 32, or the camera 34) has detected an obstacle when the vehicle is within a parking area off a road.

If the configuration of Embodiment 1 is such that an imitation sound (alarm sound) is always output when an obstacle (including a human being) has been detected around the vehicle, there can be cases in which, depending on the width of a road or the surrounding situation, an alarm sound often comes out during travelling and rather hinders the driving.

In view of this, it may be allowed to make settings such that places where alarm sounds can be output are limited to parking areas. For similar reasons, settings may be made such that the output timing of an alarm sound is limited to the time immediately before departure (e.g., for a period of time from the start of the engine to departure, or for a certain period of time after the start of the engine). Moreover, even with a vehicle that does not have a function of detecting the surrounding environment, outputting an imitation sound from the outside-vehicle speaker 22 in parking areas is also effective to a certain degree in order to warn people around the vehicle to pay attention.

It should be noted that the present invention can be implemented by freely combining the above embodiments or by making a modification or omission on the embodiments as appropriate without departing from the scope of the present invention.

While the invention has been shown and described in detail, the foregoing description is in all aspects illustrative and not restrictive. It is therefore understood that numerous modifications and variations can be devised without departing from the scope of the invention.

### REFERENCE SIGNS LIST

10 Map data storage apparatus
100 Navigation apparatus
11 Route search unit
12 Vehicle information acquiring unit
13 Travelling road determining unit
14 Operation input unit
15 Vehicle surrounding information acquiring unit
16 Wireless communication unit
16a Infrastructure information acquiring unit
16b Distributed imitation sound information acquiring unit
17 Imitation sound synthesizer
18 Imitation sound generator
19 Controller
21 In-vehicle speaker
22 Outside-vehicle speaker
31 Infrared sensor
32 Microphone
33 Noise sensor
34 Camera
35 Rainfall sensor
36 Speed sensor
37 Tilt angle sensor
38 GPS receiver
41 Traffic information
42 Weather information
43 Hazard information
44 Distributed imitation sound information
200 Map database
210 Road network data
211 Node data
212 Link data
221 In-vehicle imitation sound data list
222 Outside-vehicle imitation sound data list

1-15. (canceled)

16. An imitation sound generation system comprising:
a storage that stores road network data that includes data regarding links, each representing each road in a road network;
a current location acquiring unit that acquires a current location;
a road determining unit that specifies a link to which said current location belongs;
an imitation sound determining unit that determines a piece of imitation sound data associated with a link to which said current location belongs, from among a plurality of pieces of imitation sound data regarding an environmental sound, a natural sound, a travelling sound, or an alarm sound; and
an imitation sound generator that outputs, to outside or inside of a vehicle, an imitation sound that corresponds to a piece of imitation sound data determined by said imitation sound determining unit.

17. The imitation sound generation system according to claim 16, wherein
said plurality of pieces of imitation sound data are each stored in said storage in association with each link.

18. The imitation sound generation system according to claim 17, further comprising:
an imitation sound data acquiring unit that acquires a plurality of pieces of new imitation sound data, each being associated with each link, through communication, wherein
in a case where a piece of imitation sound data stored in advance in said storage and a piece of new imitation sound data acquired by said imitation sound data acquiring unit are both associated with the same link, said imitation sound determining unit selects the piece of new imitation sound data acquired by said imitation sound data acquiring unit with priority.

19. The imitation sound generation system according to claim 16, further comprising:
an imitation sound data acquiring unit that acquires said plurality of pieces of imitation sound data, each being associated with each link, through communication.

20. The imitation sound generation system according to claim 16, wherein
said imitation sound determining unit changes an imitation sound that is to be output from said imitation sound generator, on the basis of information acquired through communication.

21. The imitation sound generation system according to claim 20, wherein
said information acquired through communication includes one of traffic information, weather information, and hazard information.

22. The imitation sound generation system according to claim 16, further comprising:
a surrounding information acquiring unit that detects surrounding conditions with various types of sensors,
wherein said imitation sound determining unit changes an imitation sound that is to be output from said imitation sound generator, on the basis of said surrounding conditions.

23. The imitation sound generation system according to claim 22, wherein
said sensors include one of an infrared sensor, a sound sensor, an image sensor, a rain sensor, a speed sensor, and a tilt angle sensor.

24. The imitation sound generation system according to claim 16, wherein
said data regarding links includes information regarding road-surfacing materials of the roads represented by the links, and
each of the links is associated with a piece of imitation sound data that corresponds to a road-surfacing material of a road represented by the link.

25. The imitation sound generation system according to claim 16, wherein
the imitation sound generation system is mounted on a vehicle, and
said imitation sound determining unit causes said imitation sound generator to output a predetermined imitation sound for a fixed period of time if said current location moves from a highway or a toll road to an open road.

26. An imitation sound generation system to be mounted on a vehicle, comprising:
a storage that stores map data including data regarding parking areas;
a current location acquiring unit that acquires a current location; and
an imitation sound generator that outputs a predetermined imitation sound if an obstacle is detected with a sensor of the vehicle when said current location is in a parking area.

27. The imitation sound generation system according to claim 26, wherein
said imitation sound generator outputs an imitation sound to inside and outside of said vehicle.

28. A map database storing:
road network data that includes data regarding links, each representing each road in a road network; and
information that indicates a plurality of pieces of imitation sound data, each being associated with each link.

29. The map database according to claim 28, wherein
data regarding each link includes an identifier for identifying a piece of imitation sound data associated with the link.
